(19) United States
(12) Patent Application Publication
(10) Pub. No.: US 2026/0171551 A1
(43) Pub. Date: Jun. 18, 2026

(54) BATTERY MODULE AND BATTERY PACK INCLUDING THE SAME

(71) Applicant: SAMSUNG SDI CO., LTD., Yongin-si (KR)

(72) Inventor: YUJIN LEE, Yongin-si (KR)

(21) Appl. No.: 19/254,538

(22) Filed: Jun. 30, 2025

(30) Foreign Application Priority Data
Dec. 13, 2024 (KR) 10-2024-0186479

(51) Int. Cl. H01M 10/658; H01M 10/625; H01M 10/647; H01M 50/209; H01M 50/293; H01M 50/507

(52) U.S. Cl. CPC H01M 10/658; H01M 10/625; H01M 10/647; H01M 50/209; H01M 50/293; H01M 50/507; H01M 2220/20

(57) ABSTRACT

A battery module includes a plurality of battery cells and an insulating unit between adjacent ones of the battery cells. The insulating unit includes: a first sheet including an insulating material; a second sheet facing the first sheet and including an insulating material; and an adhesive portion between the first sheet and the second sheet and coupling the first sheet and the second sheet to each other. A support portion protrudes from one surface of the adhesive portion facing the first sheet and is inserted into the first sheet.

### CROSS-REFERENCE TO RELATED APPLICATION

The present application claims priority to and the benefit of Korean Patent Application No. 10-2024-0186479, filed on Dec. 13, 2024, in the Korean Intellectual Property Office, the entire disclosure of which is incorporated herein by reference.

### BACKGROUND

### 1. Field

Aspects of embodiments of the present disclosure relate to a battery module and a battery pack including the same.

### 2. Description of the Related Art

Generally, rechargeable batteries (or secondary batteries) differ from primary batteries, which provide an irreversible conversion of chemical energy into electrical energy, in that they are designed to be repeatedly charged and discharged. Low-capacity rechargeable batteries may be used as power sources for small electronic devices, such as mobile phones, laptop computers, and computers, while large-capacity rechargeable batteries may be used as power sources for hybrid cars, electric cars, or the like.

A secondary battery may generally include an electrode assembly including a cathode, an anode, and a separator interposed between the cathode and the anode, a case accommodating the electrode assembly, and an electrode terminal electrically connected to the electrode assembly.

An electrolyte may be injected into the case to enable charging and discharging of the cell, that is, the battery, through an electrochemical reaction between the cathode, the anode, and the electrolyte. The shape of the case, which may be, for example, cylindrical or rectangular, may vary depending on the intended use of the battery.

Rechargeable batteries may be used in the form of a cell stack including multiple unit battery cells connected together in series or parallel to provide high energy density for purposes such as driving a hybrid vehicle.

The cell stack may be assembled and handled as a single unit housed in a module frame including an end block and a side plate to form a battery module, and the battery module may have a form in which the cell stack connected to the module frame is inserted inside the module housing and the module housing and the module frame are combined to each other.

A battery pack may be formed by including a plurality of such battery modules and arranging the plurality of battery modules in a pack housing.

Conventionally, an insulating unit is arranged between battery cells to prevent heat transfer from one cell to another. However, when an adhesive strength between the components forming the insulating unit is reduced and the contact between the components is released or weakened, safety is reduced during a battery cell stacking process.

The above-described information disclosed in the Background section of this disclosure is intended to improve understanding of the background of the present disclosure and, therefore, may include information that does not constitute related (or prior) art.

### SUMMARY

Embodiments of the present disclosure provide a battery module and a battery pack including the same exhibiting improved adhesive strength between a plurality of sheets forming an insulating unit and improved thermal insulation between a plurality of battery cells.

Aspects and features of the present disclosure are not limited to the aspects and features mentioned above, and other aspects and features of the present disclosure that are not mentioned may be understood by the following description and will be more clearly understood from the description of embodiments of the present disclosure. In addition, aspects and features of the present disclosure may be realized by the features and combinations thereof indicated in the claims.

A battery module, according to an embodiment of the present disclosure, includes a plurality of battery cells and an insulating unit arranged between adjacent ones of the battery cells. The insulating unit includes: a first sheet including an insulating material; a second sheet facing the first sheet and including an insulating material; and an adhesive portion between the first sheet and the second sheet and coupling the first sheet and the second sheet to each other. A support portion protrudes from one surface of the adhesive portion facing the first sheet and is inserted into the first sheet.

In an embodiment, the first sheet has an insertion portion into which the support portion is inserted.

In an embodiment, the insertion portion may extend through the first sheet.

In an embodiment, the insertion portion may have a depth in the first sheet and have a groove shape.

In an embodiment, the first sheet may have a catching portion protruding inwardly from the insertion portion.

In an embodiment, the support portion may extend along an axis passing through a center of the first sheet.

In an embodiment, a plurality of support portions may be provided, and the plurality of support portions may be spaced apart from each other.

In an embodiment, the first sheet and the second sheet may include different materials from each other.

In an embodiment, a pair of second sheets may be provided and may face each other with the first sheet therebetween.

In an embodiment, the battery module may further include a module housing accommodating the plurality of battery cells and the insulating unit.

A battery pack, according to an embodiment of the present disclosure, includes: a battery module including a plurality of battery cells and an insulating unit arranged between adjacent ones of the plurality of battery cells; and a pack housing accommodating the battery module. The insulating unit includes: a first sheet including an insulating material; a second sheet facing the first sheet and including an insulating material; an adhesive portion between the first sheet and the second sheet and coupling the first sheet and the second sheet to each other; and a support portion protruding from one surface of the adhesive portion facing the first sheet and being inserted into the first sheet.

In an embodiment, a plurality of battery modules may be provided.

In an embodiment, the battery pack may further include a bus bar electrically connecting ones of the plurality of battery modules to each other.

In an embodiment, the first sheet may have an insertion portion into which the support portion is inserted.

In an embodiment, the insertion portion may extend through the first sheet.

In an embodiment, the insertion portion may have a depth in the first sheet and have a groove shape.

In an embodiment, the first sheet may have a catching portion protruding inwardly from the insertion portion.

In an embodiment, the support portion may extend along an axis passing through a center of the first sheet.

In an embodiment, a plurality of support portions may be provided, and the plurality of support portions may be spaced apart from each other.

In an embodiment, a pair of second sheets may be provided and may face each other with the first sheet therebetween.

### BRIEF DESCRIPTION OF THE DRAWINGS

These and/or other aspects and features of the present disclosure will become apparent and more readily appreciated from the following description of embodiments, taken in conjunction with the accompanying drawings, in which:

FIGS. 1A and 1B are perspective views of a battery pack according to an embodiment of the present disclosure;

FIG. 2 is a perspective view of a battery module according to an embodiment of the present disclosure;

FIG. 3 is an exploded perspective view of a plurality of battery cells and an insulating unit according to an embodiment of the present disclosure;

FIG. 4 is an exploded perspective view of an insulating unit according to an embodiment of the present disclosure;

FIG. 5 is a partial cross-sectional view taken along the line I-I′ in FIG. 3;

FIG. 6 is a partial cross-sectional view taken along the line I-I′ in FIG. 3 according to another embodiment; and

FIG. 7 is an exploded perspective view an insulating unit according to another embodiment of the present disclosure.

### DETAILED DESCRIPTION

The present disclosure will now be described more fully with reference to the accompanying drawings, in which embodiments of the present disclosure are shown. Prior to the description, terms or words used in the present specification and claims should not be interpreted as being limited to their usual or dictionary meanings but should be interpreted as having meanings and describing concepts that conform to the technical idea of the present disclosure based on the principle that the inventor can appropriately define the concept of the term in order to explain his or her own invention in the best way. Therefore, the embodiments described in the present specification and the configurations illustrated in the drawings are only some embodiments of the present disclosure and do not represent all of the technical ideas and embodiments of the present disclosure, and it should be understood that there may be various equivalents and modified examples that can replace them at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

The terms used herein are for the purpose of describing embodiments of the present disclosure and are not intended to be limiting of the present disclosure.

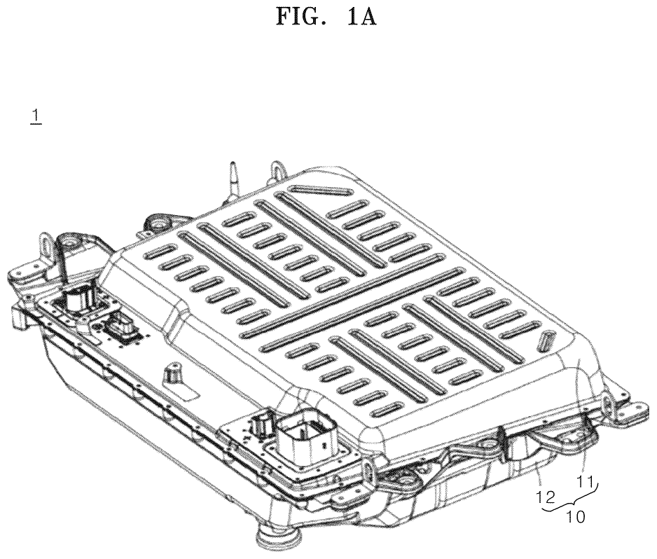

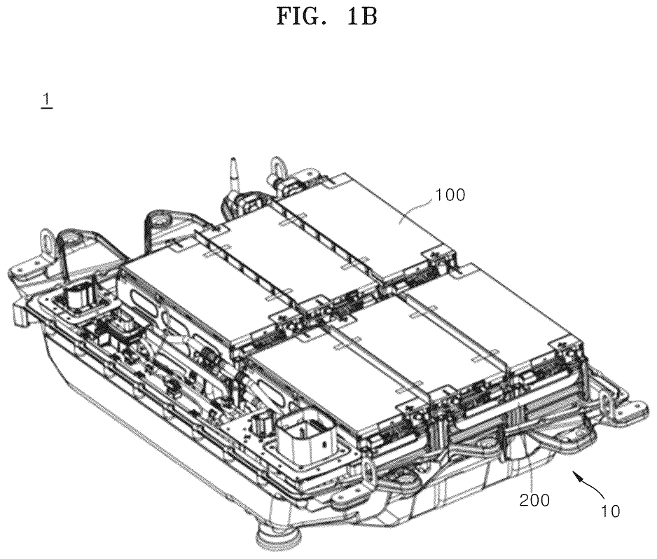

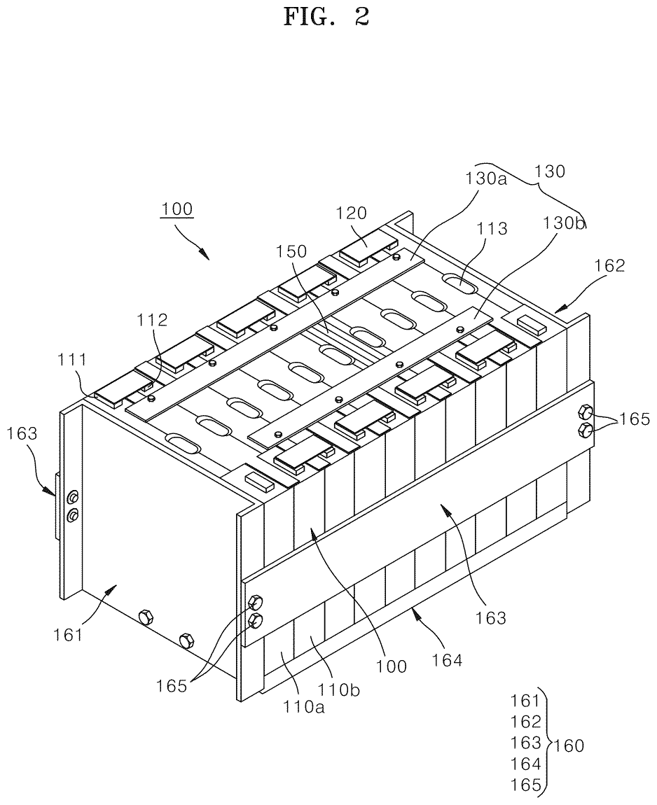

FIGS. 1A and 1B are perspective views of a battery pack according to an embodiment of the present disclosure. FIG. 2 is a perspective view of a battery module according to an embodiment of the present disclosure.

Referring to FIGS. 1A and 1B, a battery pack 1, according to an embodiment of the present disclosure, may include a battery module 100 and a pack housing 10. At least one battery pack 1 may be provided.

The pack housing 10 is hollow inside and may accommodate at least one battery module 100. In some embodiments, the pack housing 10 may accommodate a plurality of battery modules 100 and may include a first housing 11 and a second housing 12, which are coupled to each other in a direction facing each other.

Referring to FIGS. 1A and 1B, the plurality of battery modules 100 may be accommodated in an internal space formed between (or formed by) the first housing 11 and the second housing 12, which are arranged to face each other.

The plurality of battery modules 100 may be electrically connected to each other by using a bus bar 200, and the plurality of battery modules 100 may be electrically connected to each other in a series, parallel, or series-parallel hybrid manner to obtain a desired electrical output and/or capacity.

The battery pack 1, according to an embodiment of the present disclosure, may include a battery management system (BMS) for managing a battery.

Herein, the term “battery” may refer to a battery cell and a battery module including the battery cell.

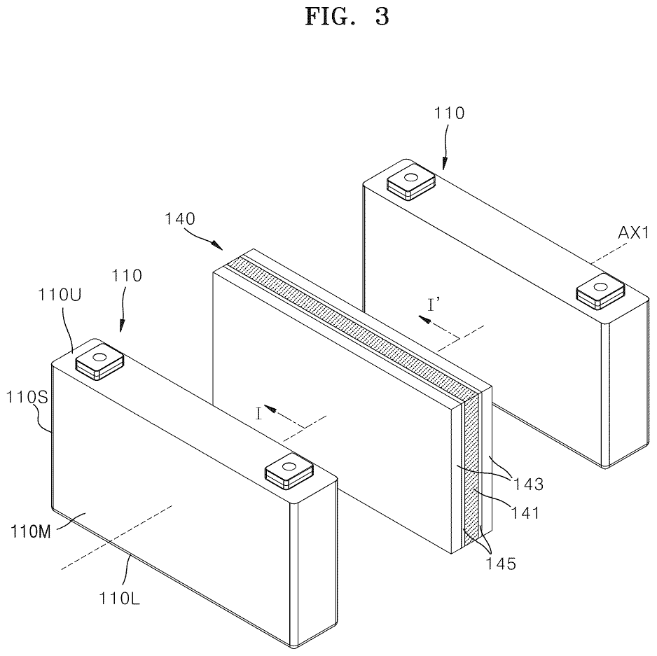

A battery management system may include a detection device, a balancing device, and a control device. The plurality of battery modules 100 may include a plurality of battery cells 110 (see, e.g., FIG. 3) connected to each other in series or in parallel.

The plurality of battery modules 100 may be connected to each other in series, parallel, or series-parallel combination.

The detection device may detect status information indicating the status of the battery by sensing the status (e.g., voltage, current, temperature, or the like) of the battery. The detection device may detect the voltage of each battery cell 110 or each battery module 100, which constitutes the battery.

The detection device may also detect a current flowing through a battery module 100 or respective battery modules 100 configuring the battery pack 1. The detection device may detect the battery cell 110 and/or battery module 100 and/or ambient temperature at at least one point of the battery.

The balancing device may perform a balancing operation of battery cells 110 and battery modules 100 that configure the battery. The control device may receive the status information (e.g., voltage, current, temperature, or the like) of the battery module 100 from the detection device.

The control device may monitor and calculate the status (e.g., voltage, current, temperature, state of charge (SOC), state of health (SOH), or the like) of the battery module 100 based on the status information received from the detection device.

In addition, the control device may perform control functions (e.g., temperature control, balancing control, charge/discharge control, or the like) and/or protection functions (e.g., over-discharge, over-charge, over-current prevention, short-circuit, fire extinguishing function, or the like) based on the status monitoring results.

Also, the control device may perform a wired or wireless communication function with an external device (e.g., a higher-level controller, a vehicle, a charger, or a power conversion system (PCS), or the like) of the battery pack 1.

The control device may control the charging/discharging operation and protection operation of the battery and may include a charging/discharging control unit, a balancing control unit, and a protection unit.

The BMS is a system that monitors the battery status and performs diagnostic and control, communication, and protection functions. The BMS may also calculate the charge and discharge status, calculate the battery life status, cut off battery power (e.g., perform relay control) when necessary, and may provide thermal management (e.g., cooling, heating) control.

In some embodiments, the BMS may perform a high voltage interlock (HVIL) function and may detect or calculate insulation and short circuit conditions.

A HVIL is a circuit that uses a signal (e.g., a small signal) to check whether or not all high-voltage components in an electric or hybrid vehicle system are connected and may cause the relay to open when even one open occurs at one place along the entire loop.

The relay may be a mechanical contactor that is turned on and off by the magnetic force of a coil or a semiconductor switch, such as a metal oxide semiconductor field effect transistor (MOSFET).

Relay control is a function that cuts off electricity supply from the battery when a problem occurs in a vehicle and battery system and may include one or more relays and a precharge relay non each of cathode and anode terminals.

Because the above precharge control has a risk of inrush current occurring in a high-voltage capacitor on an inverter input side when the battery load is connected, the precharge relay may be operated to connect the precharge relay to a precharge resistor before connecting the main relay when the vehicle is started to prevent inrush current from being introduced.

Referring to FIGS. 1B and 2, the battery module 100, according to an embodiment of the present disclosure, is accommodated inside the pack housing 10, and a plurality of battery modules 100 may be provided. The battery module 100 may include a plurality of battery cells 110, a connection tab 120, a protection circuit module 130, an insulating unit 140 (see, e.g., FIG. 3), a connection member 150, and a module housing 160.

Referring to FIG. 2, the plurality of battery cells 110 may be arranged in parallel in a stacked form in a direction (e.g., an alignment or arrangement direction). A battery cell 110 may have a cathode lead (or terminal) and an anode lead (or terminal). The battery cell 110 may be a circular-type, square-type, or pouch-type battery cell 110 depending on the shape of the battery (or cell).

In embodiments of the present disclosure, the battery pack 1 is configured such that the battery module 100 is accommodated in the pack housing 10, but the present disclosure is not limited thereto. A single cell stack in which battery cells 110 are stacked may configure a single module and may be accommodated in the pack housing 10.

Such a cell stack may be accommodated in a space formed inside the pack housing 10 or may be accommodated in a space separated by a frame, bulkhead, or the like.

The battery cell 110 generates a large amount of heat during charging and discharging. The generated heat accumulates in the battery cell 110 and accelerates deterioration of the battery cell 110. Accordingly, the battery pack 1 may include a cooling member to suppress the deterioration of the battery cell 110.

The cooling member is provided at the lower portion of the space where the battery cell 110 is accommodated but is not limited thereto and may be provided at the upper portion or side surface of the space where the battery cell 110 is accommodated depending on the battery pack 1.

Exhaust gases inside the battery cell 110, which are generated when the battery cell 110 experiences abnormal operating conditions, also known as thermal runaway or a thermal event, may be discharged to the outside of the battery cell 110.

The battery pack 1 or the battery module 100 may have an exhaust port or the like for discharging exhaust gas to prevent damage to the battery pack 1 or the battery module 100. The specific configuration of the battery cell 110 is known in the art, and a detailed description thereof is omitted.

Referring to FIG. 2, the battery module 100 may have a terminal part and may include a plurality of battery cells 110 arranged in one direction, the connection tab 120 connecting the plurality of battery cells 110 adjacent to each other, and the protection circuit module 130 having one end portion connected to the connection tab 120.

The protection circuit module 130 may be a BMS. The connection tab 120 may include a body part that is in contact with the terminal parts between adjacent battery cells 110 and an extension part that extends from the body part and is connected to the protection circuit module 130. The connection tab 120 may be a bus bar.

First, the battery cell 110 may include a battery case, an electrode assembly housed within the battery case, and an electrolyte. The electrode assembly and the electrolyte may react electrochemically to generate energy.

One side of the battery cell 110 may be provided with a terminal part electrically connected to the connection tab 120 and a vent that forms an exhaust path for excess gas generated inside the battery cell 110. The terminal parts of the battery cell 110 may include a cathode terminal 111 and an anode terminal 112, which have different polarities from each other.

The terminal parts of adjacent battery cells 110 may be electrically connected to each other in series or parallel by the connection tab 120. Herein, an embodiment in which the battery cells 110 are connected in parallel is described as an example, but the present disclosure is not limited to this structure or configuration and various connection structures may be used.

The number and arrangement of battery cells 110 are not limited to the structure as shown in FIG. 2 and may be varied.

A plurality of battery cells 110a and 110b may be arranged along a longitudinal central axis AX1 such that wide surfaces 110M of the battery cells 110 face each other, and the arranged plurality of battery cells 110a and 110b may be fixed by the module housing 160.

Herein, the wide surface 110M of the battery cell 110 is referred to as the “main surface”. The main surface 110M may be the front or rear surface of the battery cell 110 based on orientation as shown in FIG. 3. In the battery cell 110, surfaces connecting (or extending between) the front and rear surfaces at both sides of the front and rear surfaces may be defined as side surfaces 110S, and a surface connecting (or extending between) upper sides of the front and rear surfaces may be defined as an upper surface 110U.

Referring to FIG. 3, a surface connecting (or extending between) lower sides of the front and rear surfaces of the battery cell 110 may be defined as a lower surface 110L.

Referring to FIG. 2, the module housing 160 is hollow inside and may accommodate the plurality of battery cells 110 and the insulating unit 140 (see, e.g., FIG. 3) to be described below, which is arranged between the plurality of battery cells 110.

Referring to FIG. 2, the module housing 160 may include end plates 161 and 162, side plates 163, a bottom plate 164, and fastening members 165). The end plates 161 and 162 may face the wide surface 110M of the battery cells 110.

The side plates 163 may connect the end plates 161 and 162, which are arranged facing each other. The pair of side plates 163 may face each other and may be spaced apart from each other.

The bottom plate 164 supports the bottom surface of the battery cells 110 and may be connected to the end plates 161 and 162 and the side plate 163. The pair of end plates 161 and 162, the pair of side plates 163, and the bottom plate 164 may be connected by the fastening members 165, such as a bolt.

Referring to FIG. 2, the protection circuit module 130 may mount (or may have) electronic components, protection circuits, or the like and may be electrically connected to the connection tab 120.

The protection circuit module 130 may include a first protection circuit module 130a and a second protection circuit module 13030b, which extend at different positions in a direction in which the plurality of battery cells 110 are arranged. The first protection circuit module 130a and the second protection circuit module 130b may be spaced apart from each other at a distance and positioned parallel to each other and may be electrically connected to adjacent connection tabs 120, respectively.

For example, the first protection circuit module 130a may be formed to extend along one upper side of the plurality of battery cells 110 in the direction in which the plurality of battery cells 110 are arranged, and the second protection circuit module 130b may be formed to extend along another upper side of the plurality of battery cells 110 in the direction in which the plurality of battery cells 110 are arranged.

The second protection circuit module 130b is spaced apart from the first protection circuit module 130a at a distance with the vents of the battery cells 110 therebetween and may be arranged parallel to the first protection circuit module 130a. The two protection circuit modules (e.g., the first and second protection circuit modules 130a and 130b) are arranged to be spaced apart from each other and arranged in parallel in the direction in which the plurality of battery cells 110 are arranged, thereby reducing the area of a printed circuit board (PCB) configuring the protection circuit module 130.

By configuring the protection circuit module 130 separately into two protection circuit modules (e.g., the first and second protection circuit modules 130a and 130b), an unnecessary (or unused) area of a PCB may be reduced. In some embodiments, the first protection circuit module 130a and the second protection circuit module 130b may be connected to each other by the connection member 150 including a conductive material.

In the embodiment shown in FIG. 3, one side of the connection member 150 is connected to the first protection circuit module 130a and the other side thereof is connected to the second protection circuit module 130b so that an electrical connection may be made between the two protection circuit modules 130a and 130b.

The electrical connection between the two protection circuit modules 130a and 130b may be performed by any one of soldering, resistance welding, laser welding, or projection welding methods.

Referring to FIG. 2, the connection member 150 may be an electric wire. In some embodiments, the connection member 150 may be include a material having elasticity or flexibility.

By using such a connection member 150, the voltage, temperature, and current of the plurality of battery cells 110 may be checked and managed to be normal.

For example, information, such as the voltage, current, and temperature, received by the first protection circuit module 130a from the connection tab 120 adjacent thereto, and information, such as the voltage, current, and temperature, received by the second protection circuit module 130b from the connection tab 120 adjacent thereto may be integrated and managed by the protection circuit module 130 through the connection member 150.

In some embodiments, when one or more of the battery cells 110 swell, the movement (e.g., shock) may be absorbed by the elasticity or flexibility of the connection member 150, thereby preventing the first protection circuit module 130a and the second protection circuit module 130b from being damaged or becoming disconnected. The shape and structure of the connection member 150, according to an embodiment of the present disclosure, are not limited to the shape illustrated in FIG. 2.

Because the protection circuit module 130, according to an embodiment of the present disclosure, includes the first protection circuit module 130a and the second protection circuit module 130b, an area of a PCB configuring the protection circuit module 130 may be reduced, thereby securing additional space inside the battery module 100.

In some embodiments, work efficiency may be improved by making it easier to connect the connection tab 120 to the protection circuit module 130 and to repair the battery module 100 when an abnormality is detected.

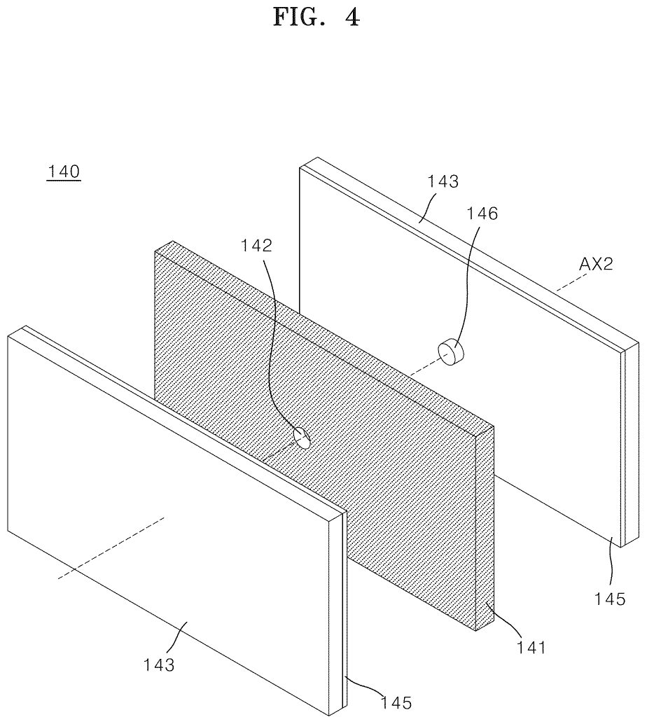

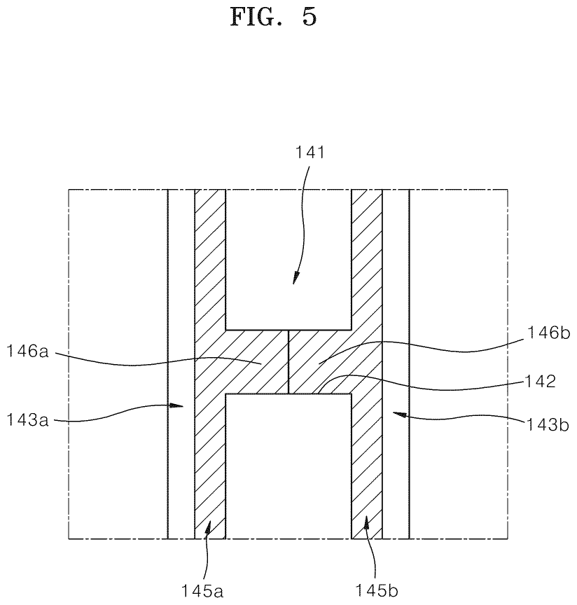

FIG. 3 is an exploded perspective view of a plurality of battery cells and an insulating unit according to an embodiment of the present disclosure. FIG. 4 is an exploded perspective view of an insulating unit according to an embodiment of the present disclosure. FIG. 5 is a partial cross-sectional view taken along the line I-I′ in FIG. 3.

Referring to FIGS. 3 to 5, an insulating unit 140, according to an embodiment of the present disclosure, may be arranged between the plurality of battery cells 110 (e.g., may be arranged between adjacent ones of the plurality of battery cells 110) and may include a first sheet 141, a second sheet 143, and an adhesive portion 145. The insulating unit 140 may be accommodated inside the module housing 160 together with the battery cells 110.

A plurality of insulating units 140 may be provided and may be arranged between respective pairs of battery cells 110, which face each other. In some embodiments, when n battery cells 110 are arranged in parallel, one of n-1 insulating units 140 may be included and respectively arranged between each pair of battery cells 110.

The first sheet 141 and the second sheet 143 may reach include an insulating material capable of blocking heat transfer between the plurality of battery cells 110 arranged in parallel.

The first sheet 141 and the second sheet 143 may include different materials. In some embodiments, the first sheet 141 may include aerogel, and the second sheet 143 may include mica.

However, the present disclosure is not limited thereto, and various modifications are possible, such as the first sheet 141 and the second sheet 143 may include the same material.

Hereinafter, the description is given based on an embodiment in which the first sheet 141 includes aerogel and the second sheet 143 includes mica, but the present disclosure is not limited thereto.

Referring to FIGS. 3 and 4, the first sheet 141 is arranged to face the second sheet 143 and may be arranged to be stacked along a stacking direction (e.g., the AX1 direction in FIG. 3) of the plurality of battery cells 110. The first sheet 141 and the second sheet 143 may be coupled to each other by the adhesive portion 145, to be described below.

Referring to FIG. 4, one surface of the first sheet 141 facing the second sheet 143 may be in surface contact with and coupled to the adhesive portion 145 to be described below.

Referring to FIGS. 3 and 4, a plurality of second sheets 143 may be provided, and the first sheet 141 may be arranged between the plurality of second sheets 143.

For example, one surface (e.g., a front surface based on FIG. 4) of the first sheet 141 along a longitudinal central axis AX2 along which the first sheet 141 and the second sheet 143 are arranged (or stacked) may be connected to the adhesive portion 145 that is coupled to any one of the plurality of second sheets 143, and another surface (e.g., a rear surface based on FIG. 4) opposite to the one surface may be connected to the adhesive portion 145 that is coupled to another one of the plurality of second sheets 143.

Referring to FIG. 4, the thickness of the first sheet 141, according to an embodiment of the present disclosure, is relatively greater than the thickness of the second sheet 143, but the present disclosure is not limited thereto, and various modifications may be implemented within the technical concept, such as forming the first sheet 141 and the second sheet 143 to have the same thickness with different insulating materials.

In another embodiment, the thickness of the first sheet 141 may be formed to be relatively less than the thickness of the second sheet 143.

Referring to FIG. 4, according to an embodiment of the present disclosure, an insertion portion (e.g., an insertion opening) 142 may be formed in the first sheet 141 so that a support portion (e.g., a support protrusion) 146 provided in the adhesive portion 145, to be described below, may be inserted thereinto.

Referring to FIG. 4, the insertion portion 142 may be formed to extend through the first sheet 141. The insertion portion 142 may be formed at the center of the first sheet 141.

From another perspective, a longitudinal central axis of the insertion portion 142 may be parallel to the longitudinal central axis AX2 in which the insulating unit 140, for example, the first sheet 141, the second sheet 143, and the adhesive portion 145 are stacked.

Accordingly, an adhesive force between the adhesive portion 145 in the central area of the first sheet 141 is improved.

Referring to FIGS. 4 and 5, because the first sheet 141 has the insertion portion 142, an inner peripheral surface of the insertion portion 142 may be in contact with and coupled to the adhesive portion 145 (e.g., the support portion 146), and a contact area between the first sheet 141 and the adhesive portion 145 may be increased.

Because the contact area between the first sheet 141 and the adhesive portion 145 is increased, a coupling force between the adhesive portion 145 and the first sheet 141 may be improved, and as a result, a coupling force between the second sheet 143, which is coupled to the adhesive portion 145, and the first sheet 141 may be improved.

Because the bonding force between the first sheet 141 and the second sheet 143, which configure the insulating unit 140, is improved, interference occurring during a process of arranging the insulating unit 140 between the plurality of battery cells 110 and forming a cell stack may be prevented.

Referring to FIG. 5, because the insertion portion 142 is extends through the first sheet 141, according to an embodiment of the present disclosure, one support portion 146a inserted into the insertion portion 142 from one side (e.g., the left side as shown in FIG. 5) and another support portion 146b inserted into the insertion portion 142 from another side (e.g., the right side as shown in FIG. 5) may be coupled to each other.

Because the support portions 146a and 146b respectively provided on different adhesive portions 145a and 145b are coupled to each other by passing through the insertion portion 142 formed in the first sheet 141, the plurality of adhesive portions 145a and 145b that are respectively coupled to a plurality of second sheets 143a and 143b on both sides based on the first sheet 141 may not be separated or detached from the first sheet 141.

In another embodiment, the respective support portions 146a and 146b, which are partially inserted into the insertion portion 142 formed in the first sheet 141, may be coupled to each other and formed as a single body.

In some embodiments, the support portions 146a and 146b respectively provided on different adhesive portions 145a and 145b may be coupled to each other through the insertion portion 142 formed through the first sheet 141. Accordingly, the adhesive portions 145a and 145bm respectively arranged on both sides of the first sheet 141m may be prevented from being separated from the first sheet 141, and the second sheets 143a and 143b, respectively coupled to respective adhesive portions 145, may also be prevented from being separated from the first sheet 141.

In another embodiment, the insertion portion 142 formed in the first sheet 141 may have a depth and a groove shape (e.g., the insertion portion 142 may not extend entirely though the first sheet 141).

When the insertion portion 142 has a groove shape, the support portions 146 formed on the adhesive portions 145 respectively coupled to the plurality of second sheets 143 arranged on both sides of the first sheet 141 may be spaced apart from each other.

The support portions 146 respectively inserted into both sides of the insertion portion 142 formed in the first sheet 141 may increase a contact area between the adhesive portions 145 and the first sheet 141 by contacting the inner peripheral surface of the insertion portion 142 and may improve a coupling force between the adhesive portion 145 to which the second sheet 143 is coupled and the first sheet 141, thereby preventing the first sheet 141 and the second sheet 143 from being separated or spaced apart during a process of arranging the insulating unit 140 between the plurality of battery cells 110.

Referring to FIGS. 3 to 5, the second sheet 143, according to an embodiment of the present disclosure, is arranged to face the first sheet 141 and may be formed in a plate shape having a flat surface.

The second sheet 143 may include an insulating material (e.g., a thermal insulating material) configured to block heat transfer between the plurality of battery cells 110 arranged in parallel. In some embodiments, the second sheet 143 may include mica.

Referring to FIG. 3 and FIG. 4, a plurality of second sheets 143 may be provided. In some embodiments, a pair of second sheets 143 may be provided and may be arranged to face each other with the first sheet 141 interposed therebetween.

For example, the plurality of second sheets 143 may be respectively arranged on both sides of (e.g., on opposite sides of) the first sheet 141. One surface of the second sheet 143, which faces the first sheet 141, may be in contact with and coupled to the adhesive portion 145.

Because the adhesive portion 145 is coupled to the first sheet 141 in a state in which the second sheet 143 and the adhesive portion 145 are coupled to each other, the insulating unit 140 may be manufactured in which the plurality of second sheets 143 are arranged on both sides of the first sheet 141 with the first sheet 141 therebetween.

Referring to FIG. 3, the second sheet 143, according to an embodiment of the present disclosure, may have one side in contact with a battery cell 110 and another side opposite thereto, which is coupled to the adhesive portion 145.

Referring to FIGS. 3 to 5, the adhesive portion 145, according to an embodiment of the present disclosure, is arranged between the first sheet 141 and the second sheet 143 and may couple the first sheet 141 and the second sheet 143 to each other.

The adhesive portion 145 may include an adhesive material, may be applied on the second sheet 143 in a flowable (e.g., a liquid) state, and may couple the first sheet 141 and the second sheet 143 to each other when being cured.

A plurality of adhesive portions 145 may be provided and arranged on both sides of the first sheet 141.

In some embodiments, the plurality of adhesive portions 145 may be arranged between any one of a pair of the second sheets 143, which are arranged on both sides of the first sheet 141, and the first sheet 141, and may be arranged between another one of the pair of the second sheets 143 and the first sheet 141.

According to an embodiment of the present disclosure, the support portion 146 may be inserted into the insertion portion 142 formed in the first sheet 141 may protrude from (or protrude on) one surface of the adhesive portion 145 facing the first sheet 141. The support portion 146 may extend along the axis AX2 passing through the center of the first sheet 141.

The support portion 146 may be formed to protrude from the center of the adhesive portion 145 toward the first sheet 141. The support portion 146 may be formed by applying a relatively thick adhesive material that forms the adhesive portion 145 at an area, for example, at the central area, on the adhesive portion 145.

In another embodiment, the support portion 146 may be formed by arranging a separate frame that is hollow inside and extends in a longitudinal direction on one surface of the adhesive portion 145 facing the first sheet 141 and injecting an adhesive material into the frame.

Referring to FIG. 4, the support portion 146, according to an embodiment of the present disclosure, may have a cylindrical shape. However, the present disclosure is not limited thereto, and various modifications are possible within the technical concept of increasing the contact area with the insertion portion 142 formed in the first sheet 141.

Referring to FIG. 5, the support portions 146a and 146b may be formed on the pair of adhesive portions 145 and 145b arranged on both sides of the first sheet 141, respectively. A plurality of support portions 146a and 146b may be inserted into and coupled to the insertion portion 142 formed in the first sheet 141.

Accordingly, compared to coupling the adhesive portion 145 to only both sides of the first sheet 141, because the respective support portions 146a and 146b connect the pair of adhesive portions 145a and 145b to each other by passing through the first sheet 141, a coupling force between the first sheet 141 and the pair of adhesive portions 145a and 145b may be improved.

In some embodiments, the coupling force between the first sheet 141 and the pair of second sheets 143, which are arranged on both sides of the first sheet 141, and the first sheet 141 may be improved through the pair of adhesive portions 145.

In some embodiments, because the coupling force between the first sheet 141 and the second sheet 143 is improved, the first sheet 141 and the second sheet 143 may be prevented from being separated during a process of arranging the insulating unit 140 between the plurality of battery cells 110.

In some embodiments, because the coupling force between the first sheet 141 and the second sheet 143 is maintained, the insulating unit 140 may block heat from being transferred from one battery cell 110 to another battery cell 110.

The insertion portion 142 formed in the first sheet 141 may have a depth and a groove shape (e.g., the insertion portion 142 may not extend entirely though the first sheet 141). In such an embodiment, the support portions 146 formed on the adhesive portions 145 respectively coupled to the plurality of second sheets 143 arranged on both sides of the first sheet 141 may be spaced apart from each other.

The support portions 146 respectively inserted into both sides of the insertion portion 142 formed in the first sheet 141 may increase a contact area between the adhesive portions 145 and the first sheet 141 by contacting the inner peripheral surface of the insertion portion 142 and may improve a coupling force between the adhesive portion 145 to which the second sheet 143 is coupled and the first sheet 141, thereby preventing the first sheet 141 and the second sheet 143 from being separated or spaced apart during a process of arranging the insulating unit 140 between the plurality of battery cells 110.

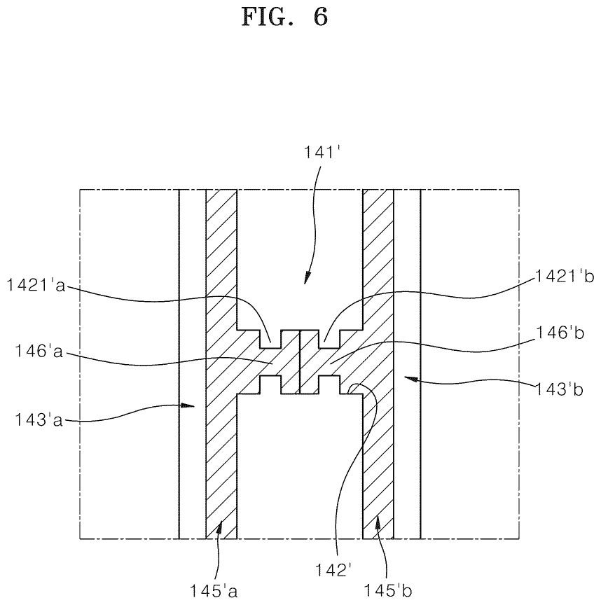

Hereinafter, a battery module according to another embodiment of the present disclosure is described. FIG. 6 is a partial cross-sectional side view of the first sheet taken along the line I-I′ in FIG. 3 according to another embodiment of the present disclosure.

A battery module according to another embodiment of the present disclosure may include a battery cell, a connection tab, a protection circuit module, an insulating unit, a connection member, and a module housing. Hereinafter, a configuration of the catching portions 1421′a and 1421′b is primarily described because the other aspects and features of the battery module are substantially similar to or the same as those described above with respect to FIGS. 1 to 5.

Referring to FIG. 6, the insulating unit may include a first sheet 141′, second sheets 143′a and 143′b, and adhesive portions 145′a and 145′b.

The first sheet 141′ may have an insertion portion 142′ into which support portions 146′a and 146′b provided on the adhesive portions 145′a and 145′b may be inserted. The insertion portion 142′ may extend through the first sheet 141′. The insertion portion 142′ may be formed at the center of the first sheet 141′.

Referring to FIG. 6, the catching portions 1421′a and 1421′b may be formed to protrude along the inner circumferential surface of the insertion portion 142′. The catching portions 1421′a and 1421′b may be formed to protrude toward a longitudinal central axis of the insertion portion 142′.

The catching portions 1421′a and 1421′b may be formed to extend along (or extend from) the inner circumferential surface of the insertion portion 142′. However, the present disclosure is not limited thereto, and a plurality catching portions may be provided and spaced apart from each other along the inner circumferential surface of the insertion portion 142′.

Referring to FIG. 6, because the catching portions 1421′a and 1421′b are formed to protrude toward the inside of the insertion portion 142′, when the support portions 146′a and 146′b are inserted into the insertion portion 142′ formed in the first sheet 141′, the support portions 146′a and 146′b may pass through an area where the catching portions 1421′a and 1421′b are formed and may be arranged on both sides (e.g., the left and right sides based on FIG. 6) of the catching portions 1421′a and 1421′b.

For example, because the support portions 146′a and 146′b formed on the adhesive portions 145′a and 145′b are hung over (e.g., extend into) the catching portions 1421′a and 1421′b, the support portions 146′a and 146′b, which are hardened, and the adhesive portions 145′a and 145′b may not be separated from the first sheet 141′, and a coupling force between the first sheet 141′ and the second sheets 143′a and 143′b may be improved.

Referring to FIG. 6, a pair of second sheets 143′a and 143′b may be arranged on both sides of the first sheet 141′, and the adhesive portions 145′a and 145′b may be respectively arranged between the pair of second sheets 143′a and 143′b and the first sheet 141′.

In some embodiments, a coupling force between the first sheet 141′ and the second sheets 143′a and 143′b arranged on both sides of the first sheet 141′ may be improved because the support portions 146′a and 146′b respectively formed to protrude on the pair of adhesive portions 145′a and 145′b are inserted into the insertion portion 142′ and are hung over the plurality of catching portions 1421′a and 1421′b arranged to be spaced apart from each other along a longitudinal direction of the insertion portion 142′.

A battery module described with reference to FIG. 6 may be substantially similar to or identical to the battery module 100 according to an embodiment of the present disclosure in terms of the battery cell, the connection tab, the protection circuit module, the connection member, and the module housing, except the specific structure of the insulating unit in which the catching portions 1421′a and 1421′b are formed to protrude on the insertion portion 142′ provided in the first sheet 141′, and thus, a detailed description redundant to the battery module 100 is omitted.

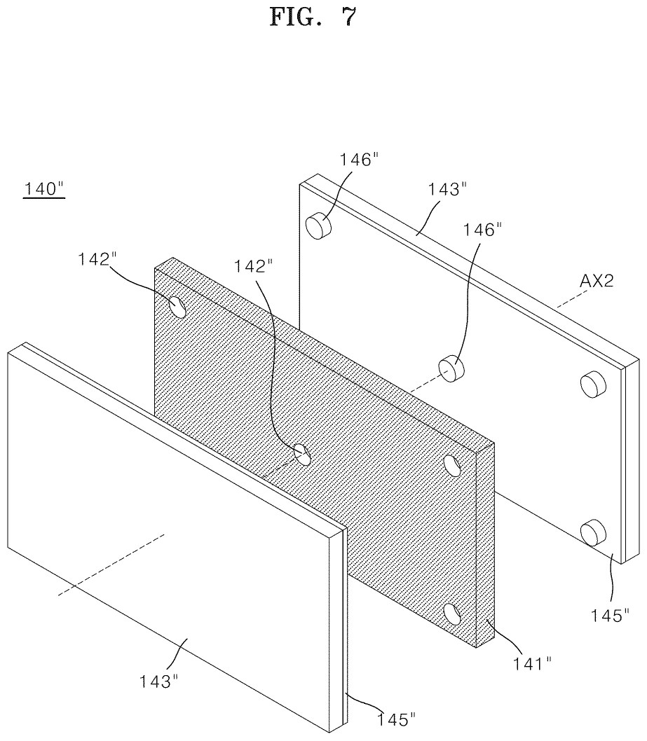

Hereinafter, a battery module according to another embodiment of the present disclosure is described. FIG. 7 is an exploded perspective view of an insulating unit according to another embodiment of the present disclosure.

Another battery module according to another embodiment of the present disclosure may include a battery cell, a connection tab, a protection circuit module, an insulating unit 140″, a connection member, and a module housing. The battery module according to another embodiment of the present disclosure has differences in terms of the specific configuration of the insulating unit 140″ in the insertion portion 142″ formed in a first sheet 141″ and a support portion 146″ formed to protrude on an adhesive portion 145″, and thus, hereinafter, the configurations of the insertion portion 142″ and the support portion 146″ are primarily described in detail.

Referring to FIG. 7, the insulating unit 140″ may include the first sheet 141″, second sheets 143″, and adhesive portions 145″. The first sheet 141″ may have an insertion portion 142″ into which the support portion 146″ provided on the adhesive portion 145″ may be inserted. The insertion portion 142″ may extend through the first sheet 141″.

Referring to FIG. 7, a plurality of insertion portions 142″ may be provided. One of the plurality of insertion portions 142″ may be formed at the center of the first sheet 141″.

In some embodiments, the plurality of insertion portions 142″ may be spaced apart from each other at equal distances from an insertion portion 142″ formed at the center of the first sheet 141″.

Referring to FIG. 7, the remaining plurality of insertion portions 142″ except for the insertion portion 142″ formed at the center of the first sheet 141″ may be respectively arranged at the corners of the first sheet 141″. However, the present disclosure is not limited thereto, and various modifications are possible, for example, a pair of insertion portions 142″ may be arranged on both sides based on the insertion portion 142″ formed at the center, and a pair of insertion portions 142″ may be arranged on upper and lower sides.

Referring to FIG. 7, a plurality of support portions 146″ may be formed to protrude on (or protrude from) one surface of the adhesive portion 145″ facing the first sheet 141″ to correspond to the plurality of insertion portions 142″.

In some embodiments, one of the plurality of support portions 146″ may be formed at the center of the adhesive portion 145″ to be insertable into the insertion portion 142″ formed at the center of the first sheet 141″. In some embodiments, a plurality of support portions 146″ may be arranged to be spaced apart from a support portion 146″ formed at the center of the adhesive portion 145″ at the same distance.

Referring to FIG. 7, the remaining plurality of support portions 146″ except for the support portion 146″ formed at the center of the adhesive portion 145″ may be respectively arranged at the corners of the adhesive portion 145″ to correspond to the positions of the remaining insertion portions 142″ formed in the first sheet 141″.

However, the present disclosure is not limited thereto, and within the technical concept corresponding to the position of the insertion portion 142″ formed in the first sheet 141″, various modifications are possible, for example, a pair of support portions 146″ may be arranged on both sides based on the support portion 146″ formed at the center of the adhesive portion 145″, and a pair of support portions 146″ may be arranged on the upper and lower sides.

A battery module according to another embodiment of the present disclosure may be substantially similar to or identical to the battery module 100 according to an embodiment of the present disclosure in terms of the battery cell, the connection tab, the protection circuit module, the connection member, and the module housing, except the specific configuration of the insulating unit 140″ in which a plurality of insertion portions 142″ formed in the first sheet 141″ are provided and a plurality of support portions 146″ formed to protrude on the adhesive portion 145″ are provided to correspond to the plurality of insertion portions 142″, and thus, a detailed description redundant to the battery module 100 is omitted.

A battery module, according to embodiments of the present disclosure, provides increased adhesive area between the first sheet and the adhesive portion so that the adhesive portion may improve a coupling force between the first sheet and a second sheet, and a support portion protruding from one surface of an adhesive portion facing a first sheet may be inserted into a first sheet.

In addition, because the adhesive portion improves the coupling force between the first sheet and the second sheet, the first sheet and the second sheet may not be separated during a process of arranging an insulating unit between a plurality of battery cells and forming a cell stack.

In addition, because the coupling force of the insulating unit, for example, the coupling force between the first sheet and the second sheet, is maintained, heat transfer from one battery cell to another battery cell may be blocked.

According to embodiments, a battery module, according to embodiments of the present disclosure, provides an improved coupling force between the first sheet and a second sheet because a support portion protruding from one surface of an adhesive portion facing a first sheet is inserted into a first sheet, thereby increasing an adhesive area between the first sheet and the adhesive portion.

In addition, because the adhesive portion improves the coupling force between the first sheet and the second sheet, the first sheet and the second sheet may not be separated during a process of arranging an insulating unit between a plurality of battery cells and forming a cell stack.

In addition, because the coupling force of the insulating unit, for example, the coupling force between the first sheet and the second sheet, is maintained, there heat transfer from one battery cell to another battery cell may be blocked.

However, aspects and features of the present disclosure are not limited to the aspects and features described above, and other aspects and features not mentioned will be clearly understood by those skilled in the art from the description of the present disclosure described below.

Although the present disclosure has been described above in connection with example embodiments and drawings thereof, the present disclosure is not limited thereto, and various modifications and variations are possible by those skilled in the art within the scope of the technical idea of the present disclosure and the equivalent scope of the claims provided below.

What is claimed is:

1. A battery module comprising:
a plurality of battery cells; and
an insulating unit between adjacent ones of the plurality of the battery cells, the insulating unit comprising:
a first sheet comprising an insulating material;
a second sheet facing the first sheet and comprising an insulating material; and
an adhesive portion between the first sheet and the second sheet and coupling the first sheet and the second sheet to each other,
wherein a support portion protrudes from one surface of the adhesive portion facing the first sheet and is inserted into the first sheet.

2. The battery module as claimed in claim 1, wherein the first sheet has an insertion portion configured to receive the support portion.

3. The battery module as claimed in claim 2, wherein the insertion portion extends through the first sheet.

4. The battery module as claimed in claim 2, wherein the insertion portion has a depth into the first sheet and has a groove shape.

5. The battery module as claimed in claim 4, wherein the first sheet has a catching portion that protrudes inwardly from the insertion portion.

6. The battery module as claimed in claim 1, wherein the support portion extends along an axis passing through a center of the first sheet.

7. The battery module as claimed in claim 1, wherein the support portion is provided in a plurality, and
Wherein ones of the plurality of support portions are spaced apart from each other.

8. The battery module as claimed in claim 1, wherein the first sheet and the second sheet comprise different materials from each other.

9. The battery module as claimed in claim 1, wherein the second sheet is provided in a pair, and
wherein the pair of second sheets face each other with the first sheet therebetween.

10. The battery module as claimed in claim 1, further comprising a module housing accommodating the plurality of battery cells and the insulating unit.

11. A battery pack comprising:
a battery module comprising a plurality of battery cells and an insulating unit arranged between adjacent ones of the plurality of battery cells; and
a pack housing accommodating the battery module;
wherein the insulating unit comprises:
a first sheet comprising an insulating material;
a second sheet facing the first sheet and comprising an insulating material; and
an adhesive portion between the first sheet and the second sheet and coupling the first sheet and the second sheet to each other, and
a support portion protruding from one surface of the adhesive portion facing the first sheet and inserted into the first sheet.

12. The battery pack as claimed in claim 11, wherein the battery module is provided in a plurality.

13. The battery pack as claimed in claim 12, further comprising a bus bar electrically connecting ones of the plurality of battery modules to each other.

14. The battery pack as claimed in claim 11, wherein the first sheet has an insertion portion into which the support portion is inserted.

15. The battery pack as claimed in claim 14, wherein the insertion portion extends through the first sheet.

16. The battery pack as claimed in claim 14, wherein the insertion portion has a depth in the first sheet and has a groove shape.

17. The battery pack as claimed in claim 16, wherein the first sheet has a catching portion protruding inwardly from the insertion portion.

18. The battery pack as claimed in claim 11, wherein the support portion extends along an axis passing through a center of the first sheet.

19. The battery pack as claimed in claim 11, wherein the support portion is provided in a plurality, and
wherein the plurality of support portions are spaced apart from each other.

20. The battery pack as claimed in claim 11, wherein the second sheet is provided in a pair, and
wherein the pair of second sheets face each other with the first sheet therebetween.
